(19) United States
(12) Patent Application Publication
(10) Pub. No.: US 2025/0207006 A1
(43) Pub. Date: Jun. 26, 2025

(54) Moisture-curable Polyurethane Hot Melt Adhesive Composition

(71) Applicant: Henkel AG & Co. KGaA, Düsseldorf (DE)

(72) Inventor: YiZhong Luo, Shanghai (CN)

(21) Appl. No.: 19/077,190

(22) Filed: Mar. 12, 2025

Related U.S. Application Data
(63) Continuation of application No. PCT/CN2022/118969, filed on Sep. 15, 2022.

(51) Int. Cl. C09J 175/08; B32B 7/12; B32B 15/04; B32B 17/06; B32B 27/06; C08G 18/12; C08G 18/40; C08G 18/42; C08G 18/48; C08G 18/76

(52) U.S. Cl. CPC C09J 175/08; B32B 7/12; B32B 15/04; B32B 17/06; B32B 27/06; C08G 18/12; C08G 18/4018; C08G 18/42; C08G 18/4277; C08G 18/4829; C08G 18/7671; B32B 2255/26; B32B 2457/00

(57) ABSTRACT

The present invention provides a moisture-curable polyurethane hot melt adhesive composition comprising at least one polyurethane prepolymer obtained by reacting components comprising (A) a polyol mixture comprising: (a) at least one polyol which is liquid at room temperature, (b) at least one crystalline polyester polyol having a melting point of less than 70° C., and (c) 0 to less than 15.4% by weight based on the total amount of the composition of at least one crystalline polyester polyol having a melting point of no less than 70° C.; with (B) at least one polyisocyanate having at least two isocyanate groups in one molecule.

### TECHNICAL FIELD

The present invention relates to a moisture-curable polyurethane hot melt adhesive composition, particularly, relates to a moisture-curable polyurethane hot melt adhesive composition exhibiting excellent flowability and bonding strength when cured, the preparation method and use thereof.

### BACKGROUND OF THE INVENTION

In the electronics field, using silicone formulations or two-component polyurethane adhesives to fill the gap between substrates is generally known as “fluid sealants” in the art. However, these fluid sealants do not provide high initial bonding strength, which results in considerable delays in production.

Moisture-curable polyurethane hot melt adhesive composition is solid at room temperature, melt to a viscous liquid when heated to a moderate temperature, and applied to substrate to be bonded. The molten adhesive composition then cools and solidifies to form initial bond to the substrate, it can further react with moisture to form crosslinking structure and achieve high final strength. Moisture-curable polyurethane hot melt adhesive composition is environment-friendly, fast curing and has high adhesion and thus are suitable for bonding various substrate materials such as polycarbonate (PC), polybutylene terephthalate (PBT), polyethylene terephthalate (PET), polyvinyl chloride (PVC), polymethyl methacrylate (PMMA), metal and inorganic glass in the electronic devices. However, the moisture-curable polyurethane hot melt adhesive composition for gap filing in electronic devices requires the adhesive to have excellent flowability without derogating other properties in terms of adhesiveness, curing time and impact resistance, etc.

Most of the prior art focused on improving the techniques of dispensing equipment to address this problem. There were few specialized in developing adhesive compositions in this regard. For example, CN101418203A discloses that chain extender and filler can greatly improve the viscosity of the adhesive. However, the filler tends to block the needle which affects the fluidity of adhesive dispensing.

Consequently, there remains a need to develop a moisture-curable polyurethane hot melt adhesive composition which exhibits excellent flowability on the substrates to achieve the purpose of gap filing without adversely affecting other important properties such as the adhesion strength.

### SUMMARY OF THE INVENTION

After intensive studies, the inventors have found that the above problems can be solved by a moisture-curable polyurethane hot melt adhesive composition comprising at least one polyurethane prepolymer obtained by reacting components comprising
(A) a polyol mixture comprising:
   (a) at least one polyol which is liquid at room temperature,
   (b) at least one crystalline polyester polyol having a melting point of less than 70° C., and
   (c) 0 to less than 15.4% by weight based on the total amount of the composition of at least one crystalline polyester polyol having a melting point of no less than 70° C.;
   with
(B) at least one polyisocyanate having at least two isocyanate groups in one molecule.

In another aspect of the invention, provided is a method for preparing a moisture-curable polyurethane hot melt adhesive composition of the present invention.

In an additional aspect of the present invention, provided is a laminate comprising a first substrate, a second substrate, and an adhesive layer sandwiched therebetween, wherein the first and second substrates are independently of each other selected from a glass, a resin, a metal and a polyolefin, and the adhesive layer being formed by curing the adhesive composition of the present invention.

In an additional aspect of the invention, provided is an electronic device comprising the article of the present invention.

In yet another aspect of the invention, provided is the use of the adhesive composition and the laminate of the present invention in a touch screen, a cellphone, a liquid crystal display, a polymer panel, a film, a conductive layer, a protective layer, or an ink layer.

The present invention features a moisture-curable polyurethane hot melt adhesive composition having an excellent flowability on various substrates and good bonding strength when cured.

### DETAILED DESCRIPTION OF THE INVENTION

It is to be understood by one of ordinary skill in the art that the present invention is a description of exemplary embodiments only, and is not intended as limiting the broader aspects of the present invention. Each aspect so described may be combined with any other aspect or aspects unless clearly indicated to the contrary. In particular, any feature indicated as being preferred or advantageous may be combined with any other feature or features indicated as being preferred or advantageous.

Unless specified otherwise, in the context of the present invention, the terms used are to be construed in accordance with the following definitions.

Unless specified otherwise, as used herein, the terms “a”, “an” and “the” include both singular and plural referents.

The terms “comprising” and “comprises” as used herein are synonymous with “including”, “includes” or “containing”, “contains”, and are inclusive or open-ended and do not exclude additional, non-recited members, elements or process steps.

Unless specified otherwise, the recitation of numerical end points includes all numbers and fractions subsumed within the respective ranges, as well as the recited end points.

The molecular weights refer to number average molecular weights (Mn), unless otherwise stipulated. All molecular weight data refer to values obtained by gel permeation chromatography (GPC), unless otherwise stipulated, e.g. according to DIN 55672.

All references cited in the present specification are hereby incorporated by reference in their entirety.

Unless otherwise defined, all terms used in the present invention, including technical and scientific terms, have the meaning as commonly understood by one of the ordinary skilled in the art to which the present invention belongs.

The present invention is directed to a moisture-curable polyurethane hot melt adhesive composition comprising at least one polyurethane prepolymer obtained by reacting components comprising
(A) a polyol mixture comprising:
   (a) at least one polyol which is liquid at room temperature,
   (b) at least one crystalline polyester polyol having a melting point of less than 70° C., and
   (c) 0 to less than 15.4% by weight based on the total amount of the composition of at least one crystalline polyester polyol having a melting point of no less than 70° C.;
   with
(B) at least one polyisocyanate having at least two isocyanate groups in one molecule.

### Polyurethane Prepolymer

The moisture-curable polyurethane hot melt adhesive composition comprises at least one polyurethane prepolymer obtained by reacting components comprising a polyol mixture with at least one polyisocyanate having at least two isocyanate groups in one molecule.

In one embodiment, the amount of the isocyanate-functional polyurethane prepolymer in the present invention is from 60 to 99.9% by weight, preferably from 65 to 95% by weight, based on the total weight of the adhesive composition.

In some embodiments, the polyurethane prepolymer of the present invention has an NCO content of from 1.3% to 6% by weight.

In other embodiments, the polyurethane prepolymer has a number average molecular weight of from 5,000 to 30,000 g/mol, preferably from 8,000 to 15,000 g/mol, and more preferably from 8,500 to 10,000 g/mol.

### (A) Polyol Mixture

According to the present invention, the said polyol mixture (A) comprises (a) at least one polyol which is liquid at room temperature, (b) at least one crystalline polyester polyol having a melting point of less than 70° C.; and (c) 0 to less than 15.4% by weight based on the total amount of the composition of at least one crystalline polyester polyol having a melting point of no less than 70° C.

### (a) Liquid Polyol

According to the present invention, the said polyol mixture used in the present invention comprises at least one polyol which is liquid at room temperature. The liquid polyol can provide flowability properties to the adhesive composition.

Accordingly, the liquid polyol has a glass transition temperature (Tg) of no larger than 0° C., preferably from −100° C. to 0° C., more preferably from −50° C. to 0° C. If the Tg of the liquid polyol is too high, it is more difficult to be in liquid status.

In some embodiments, the at least one polyol liquid at room temperature can be selected from liquid polyester polyol and/or liquid polyether polyol.

Examples of liquid polyester polyols can be obtained by ring opening polymerization of a lactone such as ε-caprolactone and/or be derived from diols and diacids. Examples of diols useful in preparing preferred polyester polyols include ethylene glycol, diethylene glycol, 1,3-propylene glycol, 1,4-butanediol, 1,5-pentanediol, 1,6-hexanediol, 1,8-octanediol, 1,10-decanediol, and mixtures thereof. Examples of diacids useful in preparing preferred polyester polyols include succinic acid, glutaric acid, adipic acid, suberic acid, azelaic acid, sebacic acid, and 1,12-dodecanedioic acid, dimer acid, and mixtures thereof. Included within the scope of useful diacids are various diacid derivatives such as carboxylate esters (especially the methyl and ethyl esters), acid halides (such as acid chlorides) and acid anhydrides, and mixtures thereof.

Specific examples of suitable liquid polyester polyols include poly(hexanediol adipate) polyol, poly(butanediol adipate) polyol, poly-epsilon-caprolactone polyol, poly(hexanediol dodecanedioate) polyol, poly(hexanediol adipic acid terephthalate) polyol, and mixture thereof.

Alternatively, liquid polyether polyol can be used in the present invention. Compared with liquid polyester polyol, using liquid polyether polyol in the composition would increase the bonding strength of the adhesive composition when cured. These liquid polyether polyols can be obtained by copolymerizing at least one compound of ethylene oxide, propylene oxide, butylene oxide, tetrahydrofuran, etc. with at least one compound having at least two active hydrogen atoms on average in one molecule such as the polyhydric alcohols list above which include ethylene glycol, propylene glycol, dipropylene glycol, glycerol, and mixtures thereof. Other suitable polyhydric compounds include sucrose, ethylenediamine, propylenediamine, triethanolamine, 1,2-propanedithiol, and mixtures thereof.

Preferred liquid polyether polyols can be polypropanediol, polytetramethylene ether glycol, poly(oxypropylene) glycol, polyethylene oxide, polybutylene oxide, and ethylene oxide endcapped versions of any of the foregoing. The most preferred polyether polyols are polytetramethylene ether glycol, poly(oxypropylene) glycol, and ethylene oxide endcapped poly(oxypropylene)glycol.

In preferred embodiments, the liquid polyol has a number average molecular weight of from 400 to 8,000 g/mol, preferably from 500 to 5,000 g/mol, and more preferably from 1,000 to 4,000 g/mol.

The liquid which is polyol at room temperature can be used signally or a combination of at least two different liquid polyols.

It is possible to use commercially available products in the present invention. Suitable commercially available liquid polyether polyols include Voranol™ 2104, 2110, 2120, 2140 from Dow Chemical Company. And suitable commercially available liquid polyester polyols are sold under the DYNACOLL 7200 series of trade designations from Evonik Industries AG (Germany) including DYNACOLL 7210, 7230, 7231, 7250, 7255, etc.

With particular preference, the component (a) can be incorporated in an amount of from more than 0 to 60% by weight, preferably from 10% to 60%, and more preferably from 15% to 50% by weight, based on the total weight of the composition.

(b) Crystalline Polyester Polyol Having a Melting Point of Less than 70° C.

According to the present invention, the said polyol mixture used in the present invention comprises at least one crystalline polyester polyol having a melting point of less than 70° C. (b).

The term of “melting point” used herein is determined by melting curve obtained by Differential Scanning Calorimetry (DSC) method.

In preferred embodiments, the component (b) comprises at least one crystalline polyester polyol having a melting point of less than 60° C., more preferably from 40° C. to 55° C. In particularly preferred embodiments, the component (b) comprises at least two crystalline polyester polyols having different melting point within the aforementioned range.

In preferred embodiments, the component (b) has a number average molecular weight of from 1,000 to 20,000 g/mol, preferably from 2,000 to 15,000 g/mol, and more preferably from 2,000 to 8,000 g/mol.

Examples of such crystalline polyester polyols having a melting point of less than 70° C. can be obtained by ring opening polymerization of a lactone such as ε-caprolactone and/or be derived from diols and diacids. Examples of diols useful in preparing preferred polyester polyols include ethylene glycol, diethylene glycol, 1,3-propylene glycol, 1,4-butanediol, 1,5-pentanediol, 1,6-hexanediol, 1,8-octanediol, 1,10-decanediol, and mixtures thereof. Examples of diacids useful in preparing preferred polyester polyols include succinic acid, glutaric acid, adipic acid, suberic acid, azelaic acid, sebacic acid, and 1,12-dodecanedioic acid, dimer acid, and mixtures thereof. Included within the scope of useful diacids are various diacid derivatives such as carboxylate esters (especially the methyl and ethyl esters), acid halides (such as acid chlorides) and acid anhydrides, and mixtures thereof.

In a preferred embodiment, the component (b) comprises at least one crystalline polycaprolactone polyol having a melting point of less than 70° C. The polycaprolactone polyol is polyester polyol produced by ε-caprolactone being ring-opening polymerized with polyol initiator or polyamine initiator. The polyol initiators that may be used include, for example, diols, such as ethylene glycol, propylene glycol, 1,4-butylene glycol, 1,3-butylene glycol, 1,6-hexanediol, neopentyl glycol, bisphenol A, and resorcin, triols, such as glycerin, 1,2,6-hexanetriol, and 1,1,1-tris(hydroxymethyl) propane, tetraols, such as pentaerythritol, erythritol, and methyl glucoside, hexaols, such as sorbitol and dipentaerythritol, and octanols, such as sucrose. The polyamine initiators that may be used include, for example, diamines, such as ethylenediamine, propylenediamine, hexamethylenediamine, and hydrazine, and at least trifunctional polyamines, such as diethylenetriamine, triethylenetetramine, and tetraethylenepentamine. These initiators may be used singly or in combination of two or more. of these initiators, diols and diamines may preferably be used.

Specific examples of suitable crystalline polyester polyols having a melting point of less than 70° C. include poly(hexanediol adipate) polyol, poly(butanediol adipate) polyol, poly-epsilon-caprolactone polyol, poly(hexanediol dodecanedioate) polyol, poly(hexanediol adipic acid terephthalate) polyol, polycaprolactone polyol, and mixture thereof.

Suitable commercially available crystalline polyester polyols having a melting point of less than 70° C. are sold under the DYNACOLL 7300 series of trade designations from Evonik Industries AG (Germany) including DYNACOLL 7360, 7361, 7362, 7363, 7365, 7381, etc.; and under the CAPA™ series of trade designations from Ingevity including CAPA™ 2201, 2205, 2209, 2302, 2304, 2402 etc. Suitable commercially available crystalline polycaprolactone polyol having a melting point of less than 70° C. used as component (b) are 205, 208, 210, 210CP from Daicel.

With particular preference, the component (b) can be incorporated in an amount of from more than 0 to 80% by weight, preferably from 10% to 80%, and more preferably from 15% to 60% by weight, based on the total weight of the composition.

(c) Crystalline Polyester Polyol Having a Melting Point of No Less than 70° C.

According to the present invention, the said polyol mixture used in the present invention comprises 0 to less than 15.4% by weight of at least one crystalline polyester polyol having a melting point of no less than 70° C., based on the total amount of the composition.

In preferred embodiments, the said polyol mixture does not comprise any crystalline polyester polyol having a melting point of no less than 70° C. (c). In other embodiments, the crystalline polyester polyol shall be present in an amount of from 0 to less than 15.4% by weight, preferably from 0 to less than 12% by weight, more preferably from 0 to less than 11% by weight, even more preferably from 0 to less than 5% by weight, based on the total amount of the composition, otherwise the flowability of the adhesive composition will be dramatically decreased.

In preferred embodiments, the crystalline polyester polyols having a melting point of no less than 70° C. to 120° C. is used as component (c) of the present invention.

Specific examples of suitable crystalline polyester polyols having a melting point of no less than 70° C. include poly(hexanediol dodecanedioic acid) polyol, poly(butanediol dodecanedioic acid) polyol, and mixture thereof.

Suitable commercially available crystalline polyester polyols having a melting point of no less than 70° C. are DYNACOLL 7380, 7330, 7340, etc. from Evonik Industries AG (Germany).

### (B) Polyisocyanate

The moisture-curable polyurethane hot melt adhesive composition comprises at least one polyurethane prepolymer obtained by reacting (A) a polyol mixture of the present invention with (B) at least one polyisocyanate having at least two isocyanate groups in one molecule.

In preferred embodiments, the ratio of component (A) to component (B) is selected such that the molar ratio of NCO to OH is 1.3 to 4.0.

Useful polyisocyanate include any suitable isocyanate having at least two isocyanate groups in one molecule including, e.g., aliphatic, cyclopaliphatic, araliphatic, arylalkyl, and aromatic isocyanates, and mixtures thereof.

Preferable polyisocyanate can be selected from 4,4-diphenylmethane diisocyanate (MDI), hydrogenated MDI (H12MDI), partly hydrogenated MDI (H6MDI), xylylene diisocyanate (XDI), tetramethylxylylene diisocyanate (TMXDI), 4,4-diphenyldimethylmethane diisocyanate, dialkylenediphenylmethane diisocyanate, tetraalkylenediphenylmethane diisocyanate, 4,4-dibenzyl diisocyanate, 1,3-phenylene diisocyanate, 1,4-phenylene diisocyanate, the isomers of toluylene diisocyanate (TDI), 1-methyl-2,4-diisocyanatocyclohexane, 1,6-diisocyanato-2,2,4-trimethylhexane, 1,6-diisocyanato-2,4,4-trimethylhexane, 1-isocyanatomethyl-3-isocyanato-1,5,5-trimethylcyclohexane (IPDI), tetramethoxybutane-1,4-diisocyanate, naphthalene-1,5-diisocyanate (NDI), butane-1,4-diisocyanate, hexane-1,6-diisocyanate (HDI), dicyclohexylmethane diisocyanate, 2,2,4-trimethylhexane-2,3,3-trimethylhexamethylene diisocyanate, cyclohexane-1,4-diisocyanate, ethylene diisocyanate, methylenetriphenyltriisocyanate (MIT), phthalic acid bisisocyanatoethyl ester, trimethylhexamethylene diisocyanate, 1,4-diisocyanatobutane, 1,12-diisocyanatododecane, and dimer fatty acid diisocyanate, lysine ester diisocyanate, 4,4-dicyclohexylmethane diisocyanate, 1,3-cyclohexane or 1,4-cyclohexane diisocyanate, and mixtures thereof. The most preferred polyisocyanate is 4,4-diphenylmethane diisocyanate (MDI) and its isomers, chain-extended MDI, and mixtures thereof.

Useful commercially available polyisocyanate includes MONDUR ML® from Covestro, ISONATE™ 50 OP and ISONATE™ 125M from Dow Chemical Company and Desmodur® 44C available from Covestro Polymers (China) Co., Ltd.

With particular preference, the component (B) can be incorporated in the adhesive composition in an amount of from 5% to 50%, preferably from 10% to 35% by weight, and preferably from 10% to 30% by weight, based on the total weight of the composition.

### Thermoplastic Resin

The adhesive composition according to the present invention further optionally comprises at least one thermoplastic resin to provide the adhesive composition with high strength.

For purposes of this invention, a thermoplastic resin is distinct from a thermosetting resin which solidifies via crosslinking or curing when subjected to heat and/or to a suitable curing agent. The thermoplastic resin described herein includes any non-reactive thermoplastic resin preferably essentially free of unreacted and monomeric isocyanates.

Suitable thermoplastic resin can be selected from polyesters, phenoxy resins, phenolic resins, acrylic polymers, acrylic block copolymers, acrylic polymers having tertiaryalkyl amide functionality, polysiloxane polymers, polystyrene copolymers, polyvinyl polymers, divinylbenzene copolymers, polyetheramides, polyvinyl acetals, polyvinyl butyrals, polyvinyl acetols, polyvinyl alcohols, polyvinyl acetates, polyvinyl chlorides, methylene polyvinyl ethers, cellulose acetates, styrene acrylonitriles, amorphous polyolefins, thermoplastic urethanes, polyacrylonitriles, ethylene vinyl acetate copolymers, ethylene vinyl acetate terpolymers, functional ethylene vinyl acetates, ethylene acrylate copolymers, ethylene acrylate terpolymers, ethylene butadiene copolymers and/or block copolymers, styrene butadiene block copolymers, polycaprolactone, and mixture thereof.

In preferred embodiments, the thermoplastic resin has a number average molecular weight of from 8,000 to 100,000 g/mol, preferably from 8,000 to 80,000 g/mol, and more preferably from 20,000 to 50,000 g/mol.

With particular preference, the thermoplastic resin is present in the adhesive composition in an amount of from 0% to 40% by weight, and preferably from 5% to 30% by weight, based on the total weight of the composition.

### Other Components

Other additives may be added to the adhesive compositions. Such additives can be those commonly used in the art, such as colorants, antioxidants, etc.

Examples of colorants include pigments which may be selected from metal oxide pigments, titanium dioxide, optionally surface-treated, zirconium oxide or cerium oxide, zinc oxide, iron oxide (black, yellow or red), chromium oxide, manganese.

Examples of antioxidants include phenolic types such as BHT (butylated hydroxytoluene), octadecyl-3,5-bis(1,1dimethyl)-4-hydroxybenzene-propanoate, and pyrogallol; phosphites such as triphenyl phosphite, tris(nonylphenyl) phosphite; or thioesters such as dilauryl thiodipropionate.

### Adhesive Composition

In preferred embodiments, the present invention provides a moisture-curable polyurethane hot melt adhesive composition, comprising, based on the total weight of the composition:
from more than 0 to 60% by weight, preferably from 10% to 60%, and more preferably from 15% to 50% by weight of at least one polyol which is liquid at room temperature;
from more than 0 to 80% by weight, preferably from 10% to 80%, and more preferably from 15% to 60% by weight of at least one crystalline polyester polyol having a melting point of less than 70° C.;
from 0 to less than 15.4% by weight, preferably from 0 to less than 12% by weight, more preferably from 0 to less than 11% by weight, and even more preferably from 0 to less than 5% by weight of at least one crystalline polyester polyol having a melting point of no less than 70° C.; and
from 5% to 50%, preferably from 10% to 35% by weight, and preferably from 10% to 30% by weight of at least one polyisocyanate having at least two isocyanate groups in one molecule.

The method of preparing a moisture-curable polyurethane hot melt adhesive composition comprises the following steps:
(i) mixing the polyols and thermoplastic resin, if present, at the temperature from 110 to 160° C. and then vacuuming;
(ii) decreasing the reaction temperature and adding polyisocyanate having at least two isocyanate groups in one molecule at the temperature from 70 to 130° C., and then controlling at the temperature from 90 to 130° C.;
(iii) adding optional additives to mix to homogeneity; and
(iv) discharging the mixture preferably under nitrogen protection at the temperature from 90 to 150° C.

The apparatuses for these mixing, stirring, dispersing, and the like are not particularly limited. There can be used an automated mortar, a Henschel mixer, a three-roll mill, a ball mill, a planetary mixer, a bead mill, and the like which are equipped with a stirrer and a heater. Also, an appropriate combination of these apparatuses may be used. The preparation method of the curable composition is not particularly limited, as long as a composition in which the above-described components are uniformly mixed can be obtained.

The moisture-curable polyurethane hot melt adhesive composition of the present invention can be thermally curable, preferably at a temperature of lower than 100° C., more preferably of lower than 80° C.

The moisture-curable polyurethane hot melt adhesive composition of the invention may be readily manufactured using other conventional production techniques.

### Laminate, Electronic Device and the Use

In an additional aspect of the invention, a laminate comprising a first substrate, a second substrate, and an adhesive layer sandwiched therebetween, wherein the first and second substrates are independently of each other selected from a glass, a resin, a metal and a polyolefin, and the adhesive layer being formed by curing the adhesive composition of the present invention is provided.

The first substrate and/or second substrate can be of a single material and a single layer or can include multiple layers of the same or different material. The layers can be continuous or discontinuous.

The substrates of the article descried herein can have a variety of properties including rigidity (e.g., rigid substrates i.e., the substrate cannot be bent by an individual using two hands or will break if an attempt is made to bend the substrate with two hands), flexibility (e.g., flexible substrates i.e., the substrate can be bent using no greater than the force of two hands), porosity, conductivity, lack of conductivity, and combinations thereof.

The substrates of the article can be in a variety of forms including, e.g., fibers, threads, yarns, wovens, nonwovens, films (e.g., polymer film, metallized polymer film, continuous films, discontinuous films, and combinations thereof), foils (e.g., metal foil), sheets (e.g., metal sheet, polymer sheet, continuous sheets, discontinuous sheets, and combinations thereof), and combinations thereof.

Useful substrate material used in the present invention include, e.g., polymer (e.g., polycarbonate, ABS resin (acrylonitrile-butadiene-styrene resin), liquid crystal polymer, polyolefin (e.g., polypropylene, polyethylene, low density polyethylene, linear low density polyethylene, high density polyethylene, polypropylene, and oriented polypropylene, copolymers of polyolefins and other comonomers), polyether terephthalate, ethylene-vinyl acetate, ethylene-methacrylic acid ionomers, ethylene-vinyl-alcohols, polyesters, e.g. polyethylene terephthalate, polycarbonates, polyamides, e.g. Nylon-6 and Nylon-6,6, polyvinyl chloride, polyvinylidene chloride, cellulosics, polystyrene, and epoxy), polymer composites (e.g., composites of a polymer and metal, cellulose, glass, polymer, and combinations thereof), metal (aluminum, copper, zinc, lead, gold, silver, platinum, and magnesium, and metal alloys such as steel (e.g., stainless steel), tin, brass, and magnesium and aluminum alloys), carbon-fiber composite, other fiber-based composite, graphene, fillers, glass (e.g., alkali-aluminosilicate toughened glass and borosilicate glass), quartz, boron nitride, gallium nitride, sapphire, silicon, carbide, ceramic, and combinations thereof, preferably liquid crystal polymer, glass and combinations thereof.

The curable composition can be applied to a substrate using any suitable application method including, e.g., automatic fine line dispensing, jet dispensing, slot die coating, roll coating, gravure coating, transfer coating, pattern coating, screen printing, spray coating, filament coating, by extrusion, air knife, trailing blade, brushing, dipping, doctor blade, offset gravure coating, rotogravure coating, and combinations thereof. The curable composition can be applied as a continuous or discontinuous coating, in a single or multiple layers and combinations thereof.

Optionally, the surface of the substrate on which the curable adhesive composition is applied is treated to enhance adhesion using any suitable method for enhancing adhesion to the substrate surface including, e.g., corona treatments, chemical treatments (e.g., chemical etching), flame treatments, abrasion, and combinations thereof.

In an additional aspect of the invention, provided is an electronic device comprising the article of the present invention.

Exemplary electronic devices encompass computers and computer equipment, such as telecom and datacom devices, such as 5G station, or the like; printers, fax machines, scanners, keyboards and the like; medical sensors; automotive sensors and the like; wearable electronic devices (e.g., wrist watches and eyeglasses), handheld electronic devices (e.g., phones (e.g., cellular telephones and cellular smartphones), cameras, tablets, electronic readers, monitors (e.g., monitors used in hospitals, and by healthcare workers, athletes and individuals), watches, calculators, mice, touch pads, and joy sticks), computers (e.g., desk top and lap top computers), computer monitors, televisions, media players, household appliances (e.g., refrigerators, washing machines, dryers, ovens, and microwaves), light bulbs (e.g., incandescent, light emitting diode, and fluorescent), and articles that include a visible transparent or transparent component, glass housing structures, protective transparent coverings for a display or other optical component.

In yet another aspect of the invention relates to the use of the adhesive composition in a touch screen, a cellphone, a liquid crystal display, a polymer panel, a film, a conductive layer, a protective layer, or an ink layer.

### EXAMPLES

The following examples are intended to assist one skilled in the art to better understand and practice the present invention. The scope of the invention is not limited by the examples but is defined in the appended claims. All parts and percentages are based on weight unless otherwise stated.

### Raw Materials:

Voranol™ 2120 is polyether polyol which is liquid at room temperature, available from Dow Chemical Company.
XCP-244 is polyester polyol which is liquid at room temperature, available from Xuchuan Chemical Company.
Priplast 3172 is solid polyester polyol having a melting point of 40° C., available from Croda.
Dynacoll 7360 is solid polyester polyol having a melting point of 55° C., available from Evonik Industries AG.
Dynacoll 7380 is solid polyester polyol having a melting point of 70° C., available from Evonik Industries AG.
Capa™ 2302 is solid polycaprolactone polyol having a melting point of 50° C., available from Ingevity.
DESMODUR 44 C FUSED is MDI, available from Covestro.

### Test Methods:

### Horizontal Flowability Test

### Sample Preparation:

A polycarbonate substrate with 20% by weight of glass fiber which in a size of 101.6 mm*25.4 mm*1 mm was cleaned with isopropanol and idled at ambient conditions for several minutes to make sure the surface was completely dry. Then the sample composition was heated to 110° C. and kept for at least 20 minutes, then molten sample composition was dispensed onto substrate under an air pressure of 3 bars by needle. The original adhesive composition's width was controlled around 1 mm and the gap between substrate and needle was around 0.4 to 0.5 mm. After 30 seconds upon dispensing, the adhesive bead's width was measured and recorded as W1; and after 30 minutes, when the composition was completed cured, the cured bond's width was recorded as W2.

The horizontal flowability ratio was calculated based on the following formula:

$$Horizontal flowability ratio = ( W 2 - W 1 ) / W 1 * 100 \%$$

The horizontal flowability of the adhesive composition was considered to be acceptable where the horizontal flowability ratio was greater than or equal to 10%, preferably greater than 15%, more preferably greater than 25%.

### Vertical Flowability Test

### Sample Preparation:

A transparent polycarbonate (PC) substrate having a size of 101.6 mm*25.4 mm*1 mm was bonded to a stain steel (SUS) substrate with a size of 101.6 mm*25.4 mm*1 mm, forming a test specimen having a gap of 2 mm in width between PC and SUS substrates. The test specimen was placed in a position that the gap is vertical to the horizontal plane from the top to the bottom. Then the adhesive composition was heated to 110° C. and kept for at least 20 minutes, and then the molten adhesive composition was dispensed onto the top of the gap between the PC and SUS substrates to fulfill the whole gap. Finally, after 1 hour upon dispensing, the vertical height of the bond was measured and recorded.

The vertical flowability of the adhesive composition was considered to be acceptable where the vertical height of the bond was greater than or equal to 0.2 mm, preferably greater than or equal to 0.5 mm.

### Cross Tensile Strength Test

### Sample Preparation:

i. Firstly, polycarbonate substrates with 20% by weight of glass fiber which in a size of 101.6*25.4*1 mm were prepared. The substrates were cleaned with isopropanol and idled at ambient conditions for several minutes to make sure the surface was completely dry. The first substrate and the second substrate were placed crosswise and the overlapping area was to be formed an adhesive layer sandwiched therebetween.
ii. Then, two spacers with diameter of 0.127 mm were set up to control the thickness of the adhesive layer. Before dispersing the adhesive composition, the said spacers were placed at the edge of the first substrate with a distance of 3 mm from the edge of the overlapping area.
iii. After that, the adhesive composition was heated in Loctite 400D dispense machine to 110° C. for 30 minutes. A needle in 21 #size was used for dispensing the adhesive composition to the surface of ink glass. During the dispensing process, two bond line was formed by adhesive beads dispensed through the needle. The two bond lines were applied parallelly and each one had a distance of from 1.5 to 1.8 mm to the edge of the overlapping area of the two substrates. Furthermore, the distance between each adhesive bead were controlled at 8 mm, and the distance from the adhesive bead to the edge of the overlapping area of the two substrates was also 8 mm.
iv. After dispensing, the polycarbonate substrates with 20% by weight of glass fiber were pressed on it to form a sandwich construction of the overlapping area while leaving two free ends of each substrate. Then the laminate was prepared.
v. A 2-kilogram weight was applied to the sandwich construction of the overlapping area for 15 seconds. Then the weight was removed, and the resulting samples were placed at 23° C. and 50% relative humidity for 24 hours to cure the adhesive composition.

### Sample Testing:

To determine the tensile strength at break of an adhesive layer, the cross tensile strength of the samples was measured by INSTRON tensile tester with a test speed of 2 mm/min. The load at failure was recorded accordingly. The adhesive composition was considered to be acceptable where the cross tensile strength was greater than or equal to 0.5 MPa, preferably greater than or equal to 1.0 MPa.

### Examples 1 to 7 (Ex. 1 to Ex. 7) and Comparative Examples 1 to 2 (CEx. 1 to CEx. 2)

Adhesives were prepared with the following method using components in amounts (parts by weight) listed in the Table 1, and the properties were tested using the methods stated above, and the results of evaluations are shown in Table 1.

The method of preparing the moisture-curable polyurethane hot melt adhesive compositions comprises the following steps:
i. Mixing the polyols at the temperature from 110 to 160° C. and then vacuuming;
ii. Decreasing the reaction temperature and adding polyisocyanate at the temperature from 80 to 120° C., and then controlling at the temperature from 90 to 130° C.; and
iii. Discharging the mixture under nitrogen protection at the temperature from 90 to 150° C.

TABLE 1

| Components | | | | | |
|---|---|---|---|---|---|
| (part by weight) | Raw materials | CEx. 1 | Ex. 1 | Ex. 2 | Ex. 3 |
| Component (a) | Voranol ™ | 29.00 | 29.00 | 29.00 | 29.00 |
| | 2120 | | | | |
| Component (b) | Priplast 3172 | 17.50 | 17.50 | 17.50 | 17.50 |
| | Capa ™ 2302 | 14.50 | 14.50 | 14.50 | 14.50 |
| Component (c) | Dynacoll 7380 | 15.00 | 10.00 | 5.00 | 0.00 |
| Component (B) | DESMODUR | 18.00 | 18.00 | 18.00 | 18.00 |
| | 44 C FUSED | | | | |

| | | | | |
|---|---|---|---|---|
| Total weight (g) | 94 | 89 | 84 | 79 |
| Component (c) weight | 15.4% | 11.2% | 5.9% | 0% |
| percentage % | | | | |

Test Results

| | | | | |
|---|---|---|---|---|
| Horizontal flowability (%) | 0% | 10% | 25% | 50% |
| Vertical flowability (mm) | 0.02 | 0.2 | 0.5 | 2.2 |
| Cross tensile strength (MPa) | 1.6 | 1.4 | 1.2 | 0.9 |

As can be seen from Table 1, the moisture-curable polyurethane hot melt adhesive composition in the inventive examples Ex. 1 to Ex. 3, exhibited good horizontal flowability and vertical flowability performance as well as maintained satisfactory tensile strength when cured. However, in the cases where the component (c) in an amount of more than 12% by weight, the composition basically does not have any flowability to meet the application requirement.

TABLE 2

| Components | | | |
|---|---|---|---|
| (part by weight) | Raw materials | CEx. 2 | Ex. 1 |
| Component (a) | Voranol ™ 2120 | 0 | 29.00 |
| Component (b) | Priplast 3172 | 17.50 | 17.50 |
| | Capa ™ 2302 | 43.50 | 14.50 |
| Component (c) | Dynacoll 7380 | 10.00 | 10.00 |
| Component (B) | DESMODUR 44 C | 18.00 | 18.00 |
| | FUSED | | |

| | | |
|---|---|---|
| Total weight (g) | 89 | 89 |
| Component (c) weight percentage % | 11.2% | 11.2% |

Test results

| | | |
|---|---|---|
| Horizontal flowability (%) | 0 | 10% |
| Vertical flowability (mm) | 0.05 | 0.2 |
| Cross tensile strength (MPa) | 1.2 | 1.3 |

As can be seen from Table 2, two moisture-curable polyurethane hot melt adhesive compositions having the same amount of the component (c) were prepared, one was not comprised of any liquid polyol (CEx. 2) and the other was comprised of liquid polyol (Ex. 1). The result showed that without the component (a), the composition adhesive lack of required flowability.

TABLE 3

| Components | | | |
|---|---|---|---|
| (part by weight) | Raw materials | Ex. 4 | Ex. 5 |
| Component (a) | Voranol ™ 2120 | 29.00 | 29.00 |
| Component (b) | Priplast 3172 | 17.50 | 17.50 |
| | Dynacoll 7360 | 10.00 | 10.00 |
| | Capa ™ 2302 | 0.00 | 14.50 |
| Component (B) | DESMODUR 44 C | 18.00 | 18.00 |
| | FUSED | | |

| | | |
|---|---|---|
| Total weight (g) | 74.5 | 89 |

Test results

| | | |
|---|---|---|
| Horizontal flowability (%) | 23% | 38% |
| Vertical flowability (mm) | 0.9 | 0.9 |
| Cross tensile strength (MPa) | 0.75 | 1.2 |

As can be seen from Table 3, the moisture-curable polyurethane hot melt adhesive composition of the present invention having polycaprolactone polyol exhibited improved horizontal flowability and higher tensile strength when cured.

TABLE 4

| Components | | | |
|---|---|---|---|
| (part by weight) | Raw materials | Ex. 6 | Ex. 7 |
| Component (a) | Voranol ™ 2120 | 29.00 | 0.00 |
| | XCP-244 | 0.00 | 29.00 |
| Component (b) | Priplast 3172 | 17.50 | 17.50 |
| | Dynacoll 7360 | 3.00 | 3.00 |
| | Capa ™ 2302 | 21.50 | 21.50 |
| Component (B) | DESMODUR 44 C | 18.00 | 18.00 |
| | FUSED | | |

| | | |
|---|---|---|
| Total weight (g) | 89 | 89 |

Test results

| | | |
|---|---|---|
| Horizontal flowability (%) | 47% | 36% |
| Vertical flowability (mm) | 1.62 | 1.6 |
| Cross tensile strength (MPa) | 0.5 | 1.40 |

As can be seen from Table 4, compared with liquid polyester polyol, using liquid polyether polyol in the adhesive composition of the present invention would develop the bonding strength of the adhesive composition when cured.

Although some preferred embodiments have been described, many modifications and variations may be made thereto in light of the above teachings. It is therefore to be understood that the invention may be practiced otherwise than as specifically described without departing from the scope of the appended claims.

1: A moisture-curable polyurethane hot melt adhesive composition, comprising at least one polyurethane prepolymer obtained by reacting components comprising
(A) a polyol mixture comprising:
(a) at least one polyol which is liquid at room temperature,
(b) at least one crystalline polyester polyol having a melting point of less than 70° C., and
(c) 0 to less than 15.4% by weight based on the total amount of the composition of at least one crystalline polyester polyol having a melting point of no less than 70° C.;
with
(B) at least one polyisocyanate having at least two isocyanate groups in one molecule.

2: The composition according to claim 1, wherein the component (a) has a number average molecular weight of from 1,000 to 4,000 g/mol.

3: The composition according to claim 1, wherein the component (b) comprises at least one crystalline polycaprolactone polyol having a melting point of less than 70° C.

4: The composition according to claim 1, wherein the component (c) is present in an amount of from 0 to less than 5% by weight, based on the total amount of the composition.

5: The composition according to claim 1, wherein the component (B) is selected from 4,4-diphenylmethane diisocyanate (MDI), hydrogenated MDI (H12MDI), partly hydrogenated MDI (H6MDI), xylylene diisocyanate (XDI), tetramethylxylylene diisocyanate (TMXDI), 4,4-diphenyldimethylmethane diisocyanate, dialkylenediphenylmethane diisocyanate, tetraalkylenediphenylmethane diisocyanate, 4,4-dibenzyl diisocyanate, 1,3-phenylene diisocyanate, 1,4-phenylene diisocyanate, the isomers of toluylene diisocyanate (TDI), 1-methyl-2,4-diisocyanatocyclohexane, 1,6-diisocyanato-2,2,4-trimethylhexane, 1,6-diisocyanato-2,4,4-trimethylhexane, 1-isocyanatomethyl-3-isocyanato-1,5,5-trimethylcyclohexane (IPDI), tetramethoxybutane-1,4-diisocyanate, naphthalene-1,5-diisocyanate (NDI), butane-1,4-diisocyanate, hexane-1,6-diisocyanate (HDI), dicyclohexylmethane diisocyanate, 2,2,4-trimethylhexane-2,3,3-trimethylhexamethylene diisocyanate, cyclohexane-1,4-diisocyanate, ethylene diisocyanate, methylenetriphenyltriisocyanate (MIT), phthalic acid bisisocyanatoethyl ester, trimethylhexamethylene diisocyanate, 1,4-diisocyanatobutane, 1,12-diisocyanatododecane, and dimer fatty acid diisocyanate, lysine ester diisocyanate, 4,4-dicyclohexylmethane diisocyanate, 1,3-cyclohexane or 1,4-cyclohexane diisocyanate, and mixtures thereof.

6: The composition according to claim 1, wherein the at least one polyurethane prepolymer has an NCO content of from 1.3% to 6% by weight.

7: The composition according to claim 1, wherein the ratio of component (A) to component (B) is selected such that the molar ratio of NCO to OH is 1.3 to 4.0.

8: The composition according to claim 1, wherein the composition further comprises at least one thermoplastic resin.

9: The composition according to claim 8, wherein the thermoplastic resin is selected from the group consisting of polyesters, phenoxy resins, phenolic resins, acrylic polymers, acrylic block copolymers, acrylic polymers having tertiaryalkyl amide functionality, polysiloxane polymers, polystyrene copolymers, polyvinyl polymers, divinylbenzene copolymers, polyetheramides, polyvinyl acetals, polyvinyl butyrals, polyvinyl acetols, polyvinyl alcohols, polyvinyl acetates, polyvinyl chlorides, methylene polyvinyl ethers, cellulose acetates, styrene acrylonitriles, amorphous polyolefins, thermoplastic urethanes, polyacrylonitriles, ethylene vinyl acetate copolymers, ethylene vinyl acetate terpolymers, functional ethylene vinyl acetates, ethylene acrylate copolymers, ethylene acrylate terpolymers, ethylene butadiene copolymers and/or block copolymers, styrene butadiene block copolymers, polycaprolactone, and mixture thereof.

10: The composition according to claim 1, wherein the component (a) is present in an amount of from 15% to 50% by weight, based on the total weight of the composition.

11: The composition according to claim 1, wherein the component (b) is present in an amount of from 15% to 60% by weight, based on the total weight of the composition.

12: The composition according to claim 1, wherein the component (B) is present in an amount of from 10% to 30% by weight, based on the total weight of the composition.

13: A method for preparing a hot melt adhesive composition according to claim 1, comprising the steps:
(i) mixing the polyols and optionally a thermoplastic resin, at a temperature from 110 to 160° C. and then vacuuming;
(ii) decreasing the reaction temperature and adding the polyisocyanate having at least two isocyanate groups in one molecule at the temperature from 70 to 130° C., and then controlling at the temperature from 90 to 130° C.;
(iii) adding optional additives to mix to homogeneity; and
(iv) discharging the mixture under nitrogen protection at the temperature from 90 to 150° C.

14: A laminate, comprising a first substrate, a second substrate, and the moisture-curable polyurethane hot melt adhesive composition of claim 1 sandwiched therebetween, wherein the first and second substrates are independently selected from a glass, a resin, a metal or a polyolefin.

15: An electronic device, comprising the laminate of claim 14.

16: The electronic device of claim 15, which is in a touch screen, a cellphone, a liquid crystal display, and/or a polymer panel.

17: The laminate of claim 14, wherein the moisture-curable polyurethane hot melt adhesive composition is a film, a conductive layer, a protective layer, or an ink layer.
